(19) United States
(12) Patent Application Publication
(10) Pub. No.: US 2007/0047466 A1
(43) Pub. Date: Mar. 1, 2007

(54) Network management system

(75) Inventor: Gaku Todokoro, Kawasaki (JP)

Correspondence Address: KATTEN MUCHIN ROSENMAN LLP, 575 MADISON AVENUE, NEW YORK, NY, 10022-2585, US

(73) Assignee: FUJITSU LIMITED

(21) Appl. No.: 11/348,954

(22) Filed: Feb. 7, 2006

(30) Foreign Application Priority Data
Sep. 1, 2005 (JP) 2005-253025

(51) Int. Cl. G06F 15/173

(52) U.S. Cl. 370/254; 709/223

(57) ABSTRACT

Disclosed is a network management system for performing automatic setting of agent addresses to thereby improve operability and maintainability of network management. An agent node has an access list for registering an address of a partner to be permitted to make access and performs communication by a network management protocol only with the partner registered in the access list. A plurality of communication nodes perform communication by the network management protocol with the agent node. A main node controls automatic registration of communication node addresses in the access list of the agent node to allow a manager side to manage the addresses to be registered in the agent node.

### CROSS-REFERENCE TO RELATED APPLICATIONS

This application is based upon and claims the benefits of priority from the prior Japanese Patent Application No. 2005-253025, filed on Sep. 1, 2005, the entire contents of which are incorporated herein by reference.

### BACKGROUND OF THE INVENTION

1. Field of the Invention

The present invention relates to a network management system. More particularly, the present invention relates to a network management system for performing network management.

2. Description of the Related Art

An SNMP (Simple Network Management Protocol) is a protocol for allowing an operator to remotely monitor and manage network devices connected to a network, such as a router or a switch. Further, the SNMP is a protocol most often-used as a protocol for automatically monitoring and managing an operating state of network devices (the SNMP is defined in RFC (Request For Comments) 1157).

In the SNMP, a network device as a managed object is referred to as an agent and a management side is referred to as a manager. In network management using the SNMP, communication based on a UDP (User Datagram Protocol) is performed between the agent and the manager, whereby the manager obtains a device state or failure information from the agent or sets a function to the agent. Thus, the network management is realized. Further, there is recently spread the use of a system form where the manager structures a distributed environment and distributes SNMP-related control functions to establish communication with a plurality of agents.

FIG. 15 shows a configuration of an SNMP system. An SNMP system 100 is composed of a manager server 50 and agents 60-1 to 60-6 connected to a network 101.

The manager server 50 includes an HMI (Human Machine Interface) terminal 51, a main node 52 and communication nodes 53-1 to 53-3 and configures a distributed system. Each component of the manager server 50 is composed of terminal equipments and performs SNMP-related distributed processing depending on a role of each of the terminal equipments.

The HMI terminal 51 provides a GUI (Graphical User Interface) for an operator. The communication nodes 53-1 to 53-3 perform SNMP communication with an agent in charge in order to obtain state properties of agents. The main node 52 communicates with the HMI terminal 51 and the communication nodes 53-1 to 53-3 to perform a total control of the SNMP processing.

In the network management using the SNMP, when performing a request-to-send or setting change request of state properties from the manager to the agent, the agent permits the requests and then carries out the corresponding processing. Therefore, the agent must first determine whether an access is legal or not. Accordingly, with respect to the agent which must previously set the manager accessible to the agent, when the manager configures a distributed server system as shown in FIG.15, for example, when an access from the communication nodes 53-2 and 53-3 to the agent 60-1 is allowed, addresses (IP(Internet Protocol) addresses) of the communication nodes 53-2 and 53-3 must be previously registered to allow the agent 60-1 to recognize that the communication nodes accessible to the agent 60-1 are the communication nodes 53-2 and 53-3.

For a conventional technology for address setting, there is proposed a technology for automatically creating a correspondence of a network address to a physical address using a management table (Japanese Unexamined Patent Application Publication No. Hei 11-196106 (paragraph numbers [0014] to [0024], and FIG. 1)).

In the agent which manages addresses of communication nodes accessible to the agent as described above, an operator conventionally registers manually the addresses in the agents distributed on a network.

Further, in the manager server which structures a distributed environment, many communication nodes are provided as well as a correspondence of the agent to the communication node varies depending on operational conditions. Accordingly, in many cases, it is not clearly determined which communication node makes access to the agent. Therefore, all of the communication node addresses are previously registered in the respective agents in reality.

As a result, when a system scale increases, a registration work requires a long time as well as errors in registration occur and therefore, efficiency in address registration is reduced. Further, there is a problem that when registering all of the communication node addresses in the respective agents, the number of the communication nodes may be restricted by the number of addresses registerable on the agent side.

### SUMMARY OF THE INVENTION

In view of the foregoing, it is an object of the present invention to provide a network management system for performing automatic setting of agent addresses to thereby improve operability and maintainability of SNMP.

To accomplish the above objects, according to the present invention, there is provided a network management system for managing, using a network management protocol, a network device connected to a network. The network management system comprises:

an agent node as the network device having an access list for registering an address of a partner to be permitted to make access, the agent node performing communication by the network management protocol only with the partner registered in the access list, and

a manager server having a plurality of communication nodes for performing communication by the network management protocol with the agent node, and a main node for controlling automatic registration of addresses of the communication nodes in the access list to allow a manager side to manage the addresses to be registered in the agent node, the manager server performing distributed-processing a device management of the agent node by the plurality of communication nodes.

The above and other objects, features and advantages of the present invention will become apparent from the following description when taken in conjunction with the accompanying drawings which illustrate preferred embodiments of the present invention by way of example.

### BRIEF DESCRIPTION OF THE DRAWINGS

FIG. 1 is a principle view showing a network management system.

FIG. 2 shows an internal configuration of a main node and a communication node.

FIG. 3 shows a configuration example of an access list.

FIG. 4 shows a configuration example of an agent management table.

FIG. 5 shows a configuration example of a communication node management table.

FIG. 6 is a flowchart showing an operation of agent node registration.

FIG. 7 is a flowchart showing an operation of agent node registration.

FIG. 8 is a flowchart showing an operation of agent node storage change at the time when a communication node is in an abnormal state.

FIG. 9 is a flowchart showing an operation of agent node storage change at the time when a communication node is in an abnormal state.

FIG. 10 is a flowchart showing an operation of agent node storage change at the time when a communication node is in an abnormal state.

FIG. 11 is a flowchart showing an operation of agent node deletion.

FIG. 12 is a flowchart showing an operation at the time when a communication node is restored.

FIG. 13 is a flowchart showing an operation at the time when a communication node is restored.

FIG. 14 is a flowchart showing an operation at the time when a communication node is restored.

FIG. 15 shows a configuration of an SNMP system.

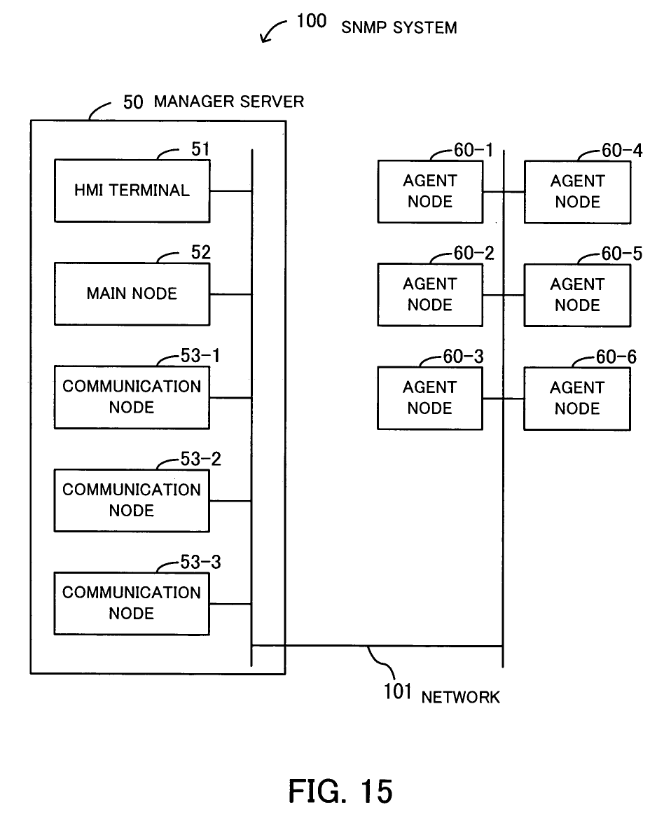

### DESCRIPTION OF THE PREFERRED EMBODIMENTS

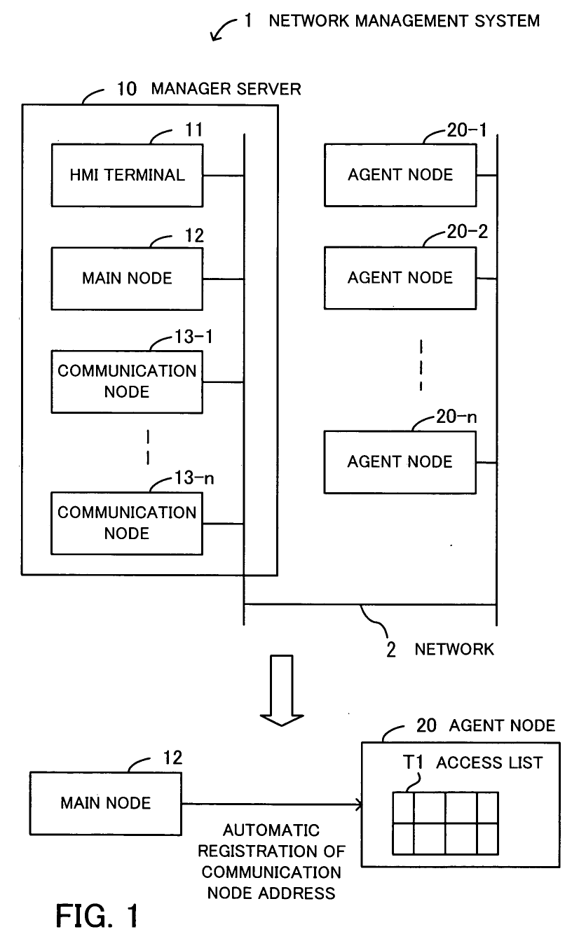

Preferred embodiments of the present invention will be described in detail below with reference to the accompanying drawings, wherein like reference numerals refer to like elements throughout. FIG. 1 is a principle view showing a network management system. The network management system 1 is composed of a manager server 10 and agent nodes 20-1 to 20-n. The system 1 is a system for managing, using a network management protocol (hereinafter, referred to as an “SNMP”) , the agent nodes 20-1 to 20-n as a plurality of network devices connected to a network 2.

Each of the agent nodes 20-1 to 20-n has an access list T1 for registering an address of a partner to be permitted to make access and performs SNMP communication only with the partner registered in the access list T1.

The manager server 10 includes an HMI terminal 11, a main node 12 and communication nodes 13-1 to 13-n and configures a distributed system. Each component of the manager server 10 is composed of terminal equipments and performs network-related distributed processing depending on a role of each of the terminal equipments.

The HMI terminal 11 provides a GUI for an operator. The communication nodes 13-1 to 13-n perform the SNMP communication with an agent node in charge in order to obtain state properties of the agent nodes 20-1 to 20-n.

The main node 12 controls automatic registration of addresses of the communication nodes 13-1 to 13-n in the access list T1 of the agent nodes 20-1 to 20-n to allow the manager side to manage the addresses to be registered in the agent nodes 20-1 to 20-n.

Further, the main node 12 has a data base for storing state properties of the agent nodes 20-1 to 20-n and analyzes the state properties of the agent nodes 20-1 to 20-n as well as transmits the analysis results to the HMI terminal 11.

For example, from data for the agent nodes 20-1 to 20-n obtained through the communication nodes 13-1 to 13-n and from past data for the agent nodes stored in the data base, the main node 12 judges a current operating state of the agent nodes. When recognizing a failure occurrence, the main node 12 notifies the HMI terminal 11 of the failure content or transmits to the HMI terminal 11 an instruction for generating an alarm.

Next, an internal configuration of the main node 12 and the communication nodes 13-1 to 13-n will be described. Hereinafter, the communication nodes 13-1 to 13-n are named generically as the communication node 13 and the agent nodes 20-1 to 20-n are named generically as the agent node 20.

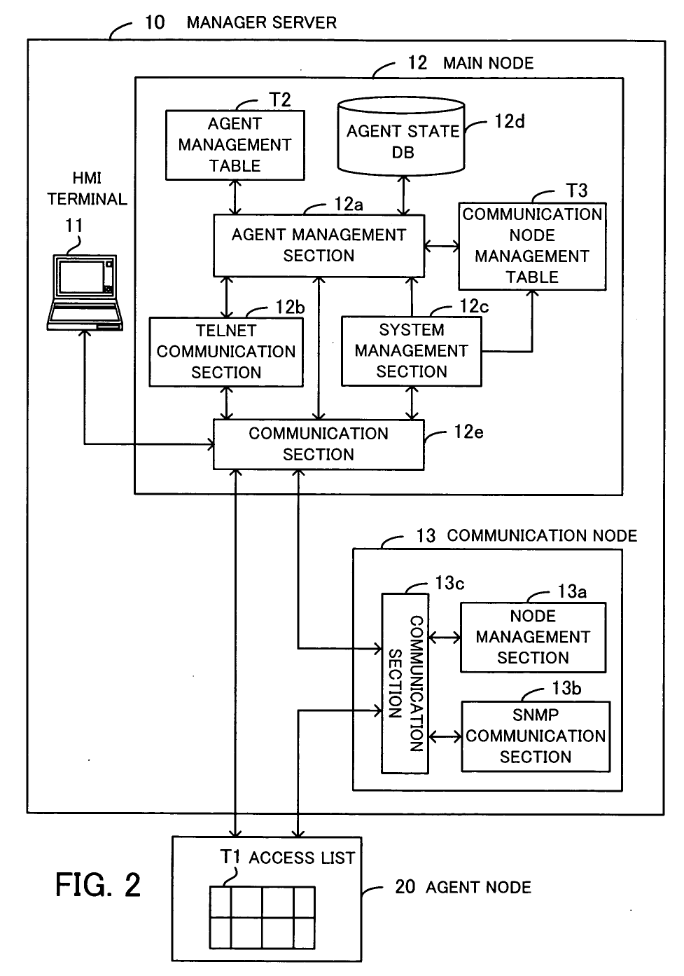

FIG. 2 shows an internal configuration of the main node and the communication node. The main node 12 is composed of a communication section 12e, an agent management section 12a, a TELNET communication section 12b, a system management section 12c, an agent state DB (data base) 12d, an agent management table T2 and a communication node management table T3. The communication node 13 is composed of a communication section 13c, a node management section 13a and an SNMP communication section 13b.

For the main node 12, the communication section 12e controls a communication interface with the HMI terminal 11, the agent node 20 and the communication node 13. The agent management section 12a performs an address registration work in the access list T1 of the agent node 20 in response to an agent registration request from the HMI terminal 11.

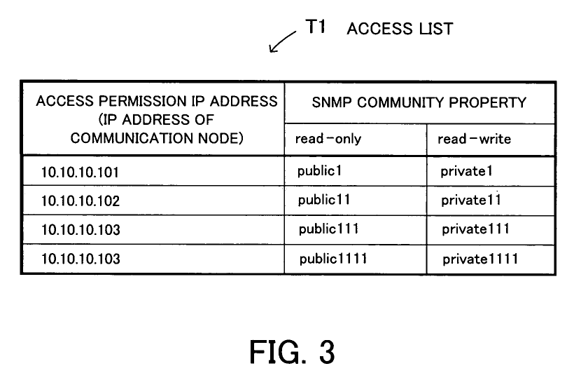

For the registration work, the agent management section 12a searches the agent management table T2/the communication node management table T3 and determines a communication node having a low processing load (further details about the access list T1, the agent management table T2 and the communication node management table T3 will be hereinafter described in FIGS. 3 to 5). Then, the section 12a controls the TELNET communication section 12b in order to register in the access list T1 of the agent node 20 an IP address of the determined communication node 13.

Further, the agent management section 12a registers the address of the communication node 13 in the access list T1 of the agent node 20. Then, the section 12a makes a request to the communication node 13 to perform SNMP access to the agent node 20 in which the IP address is registered. Thus, the section 12a allows the node 13 to collect state property information of the agent node 20 and stores the information in the agent state DB 12d. Further, when receiving a change notification of operating states of the communication node 13 from the system management section 12c, the management 12a performs storage change of the agent node 20 based on the notification.

Further, when receiving an agent deletion request from the HMI terminal 11, the agent management section 12a deletes, from the agent state DB 12d, data on the agent node 20 as a deleted object as well as deletes the address of the communication node 13 from the access list T1 of the agent node 20 while controlling the TELNET communication section 12b.

The TELNET communication section 12b performs TELNET connection to the agent node 20 in response to a request from the agent management section 12a and performs, for the access list T1, registration/change/deletion of the communication node address. Herein, the term TELNET means a standard protocol defined for use in remotely operating a computer connected to a network in the TCP/IP network.

The system management section 12c communicates with the node management section 13a within the communication node 13 to conduct the state control of each communication node. When being notified of abnormality from the node management section 13a or being unable to communicate with the node management section 13a due to breakdown in the communication node 13, the section 12c updates state data in the communication node management table T3 and notifies the agent management section 12a that the state of the communication node 13 changes.

The agent state DB 12d is a data base for storing state properties (operational information or failure information) obtained from the agent node 20. The agent management table T2 is a table for managing communication parameters of the agent node 20. The communication node management table T3 is a table for managing the operating state of the communication nodes 13-1 to 13-n.

On the other hand, for the communication node 13, the communication section 13c controls a communication interface with the agent node 20 and the main node 12. The node management section 13a monitors a state of the communication node 13 and notifies the system management section 12c of the obtained monitoring information. For example, when the communication node 13 is unable to communicate with the agent node 20 owing to decrease in the SNMP communication function, the node management section 13a notifies the system management section 12c of the effect.

The SNMP communication section 13b performs SNMP-communication with the agent node 20 in response to a request from the node management section 13a to obtain the state property information of the agent node 20 and notifies the node management section 13a of the obtained information.

Next, the access list T1, the agent management table T2 and the communication node management table T3 will be described. FIG.3 shows a configuration example of the access list T1. The access list T1 is composed of items of the access permission IP address and the SNMP community property.

The access permission IP addresses are described in a column for registering the IP addresses of communication nodes accessible to the agent node in charge. These IP addresses are automatically registered from the communication nodes 13-1 to 13-n.

The SNMP community property is a parameter serving as a password in the communication between a manger and an agent. A term “read-only” means that the communication node 13 can only read a packet (a state of the agent node) from the agent node 20 and cannot perform a setting change or reset on the agent node. A term “read-write” means that the node 13 can read a state as well as can perform a setting change or reset on the agent node. Further, a term “public” is a password used in a case of performing read-only access and a term “private” is a password used in a case of performing read/write access.

Herein, in FIG.3, to the agent node having the access list T1, when a communication node having an IP address (10.10.10.101) accesses using a public1 password as the SNMP community property, the communication node can read out information within the agent node. Further, when the communication node having the IP address (10.10.10.101) accesses using a public11 password as the SNMP community property, the communication node is prohibited from accessing to the agent node because of accessing using information different from that described in the access list T1.

As described above, in a case of issuing a request from the manager server 10 to the agent node 20, when the server 10 does not specify a correct community name, the agent side takes the access as an illegal one.

On the other hand, state property information of the agent node 20 to which the manager server 10 is accessible is referred to as a MIB (Management Information Base). The MIB is a data base of management information showing an operating state of the agent node 20.

Further, each separate piece of information stored in the MIB is referred to as an object. The object is managed using a tree structure. An object ID (OID) is allocated to each object. The manager server 10 specifies the OID so as to obtain desired information or to perform a setting change on the agent node as a monitored object.

In the above description, the manager server 10 registers the addresses of the communication nodes 13-1 to 13-n in the access list T1 in order to access the agent nodes 20-1 to 20-n. Further, when the manager server 10 manages Traps from the agent nodes 20-1 to 20-n (Trap: a message that the agent node voluntarily notifies the manager side of an internal operation), the agent nodes 20-1 to 20-n can use the access list T1 as a notification destination list of the Traps to the communication nodes 13-1 to 13-n.

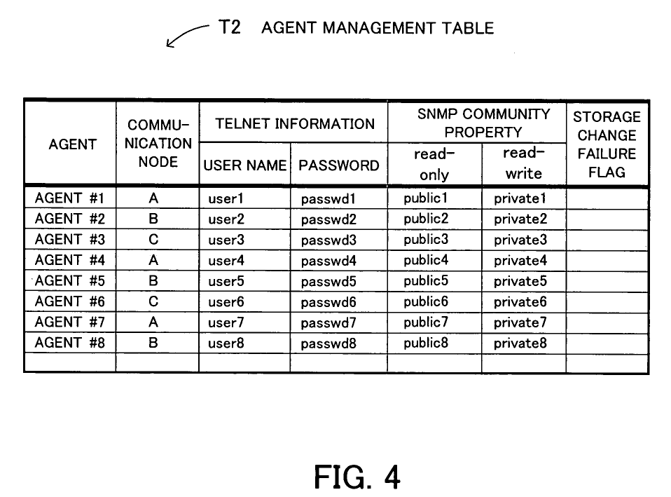

FIG.4 shows a configuration example of the agent management table T2. The agent management table T2 is a table indicating a correspondence relation between the communication nodes 13-1 to 13-n and the agent nodes 20-1 and 20-n. Further, the table T2 includes items of the TELNET information, the SNMP community property and the storage change failure flag.

The TELNET information is information composed of a user name and password which are used when a communication node logs on an agent node. In the figure, for example, when the user name is set to user1 and the password is set to passwd1, the communication node A can log on the agent node #1. A column of the storage change failure flag is a column in which a failure flag is described when failing in the storage change.

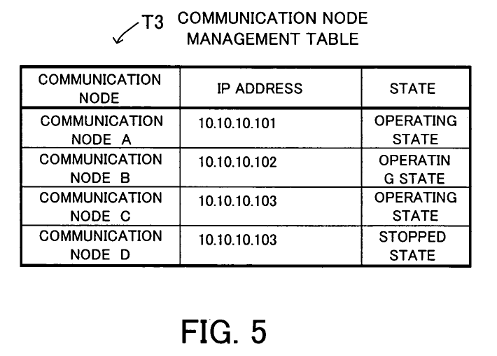

FIG. 5 shows a configuration example of the communication node management table T3. The communication node management table T3 is a table for keeping an IP address and operating state of each communication node and for referring to a registerable communication node during the registration of the communication node. In the figure, for example, the communication node A has an IP address of 10.10.10.101 and is currently at work as recognized from state data.

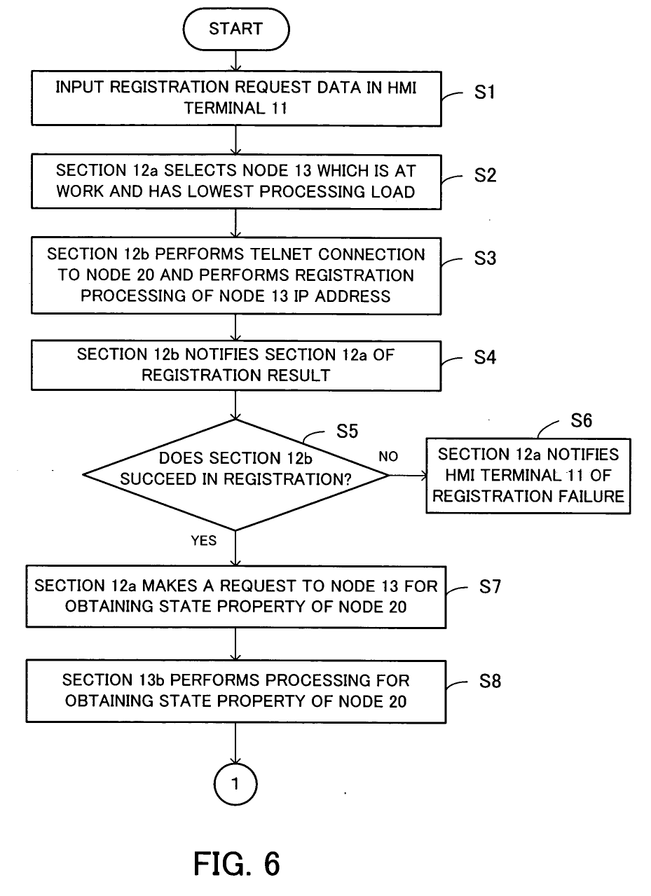

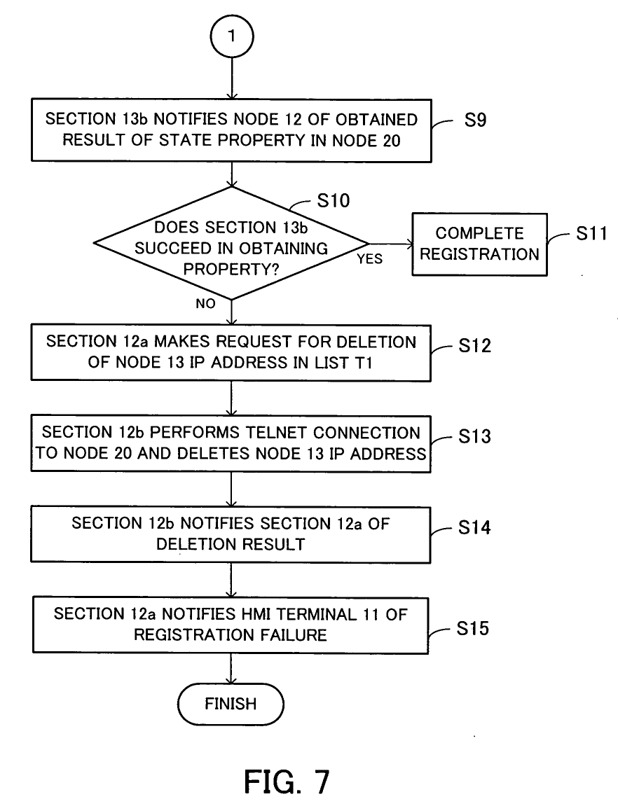

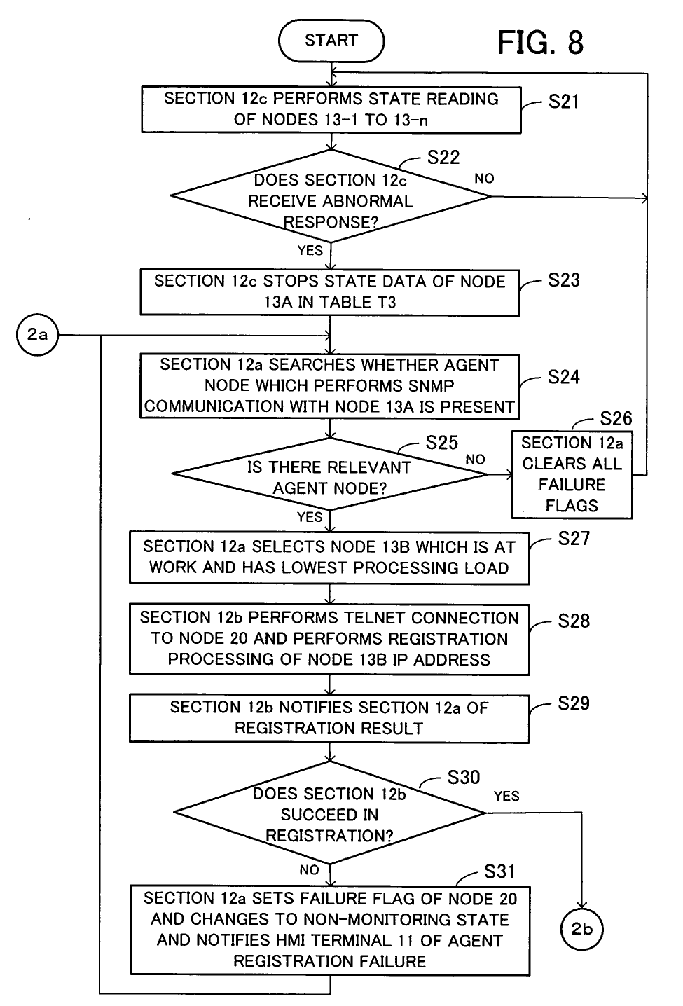

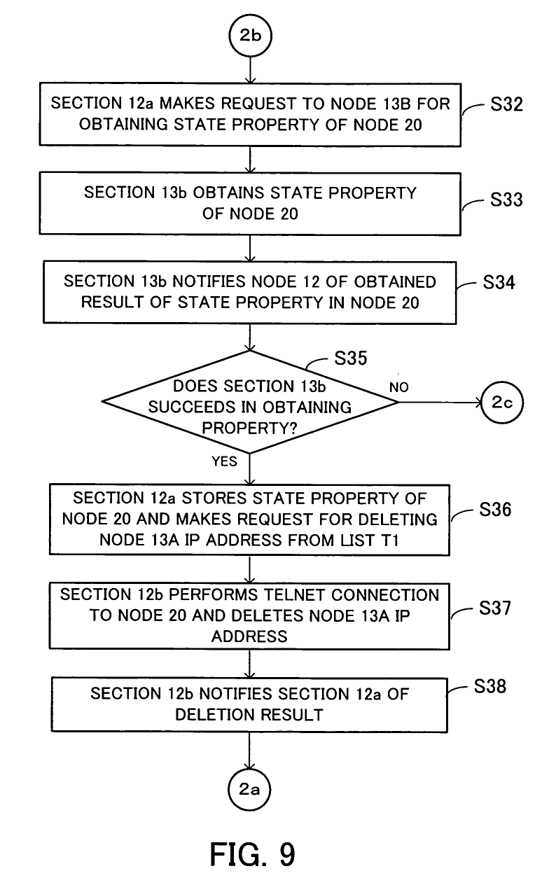

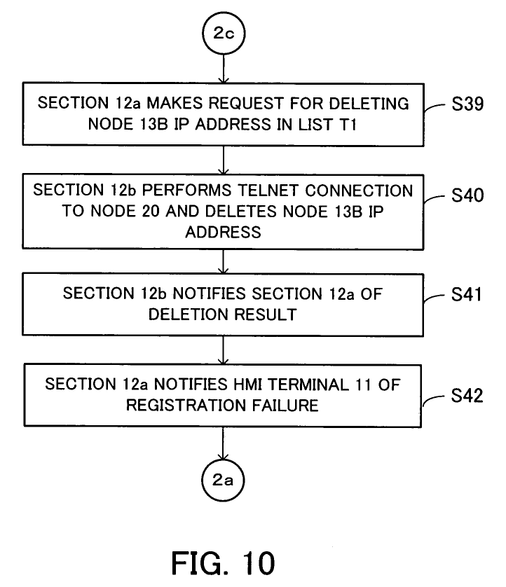

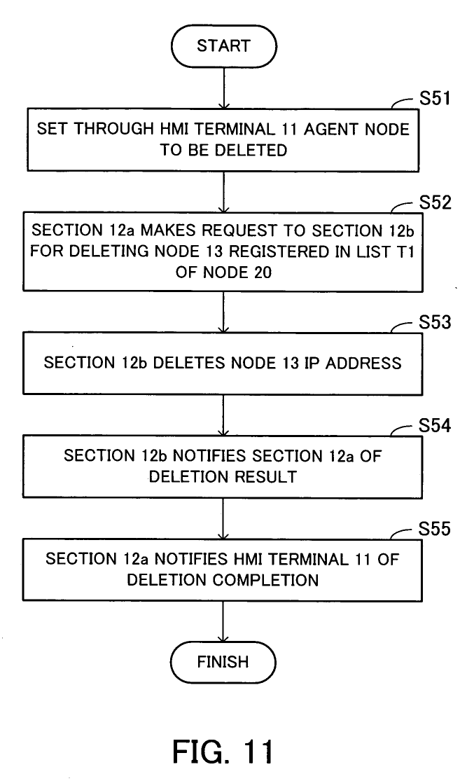

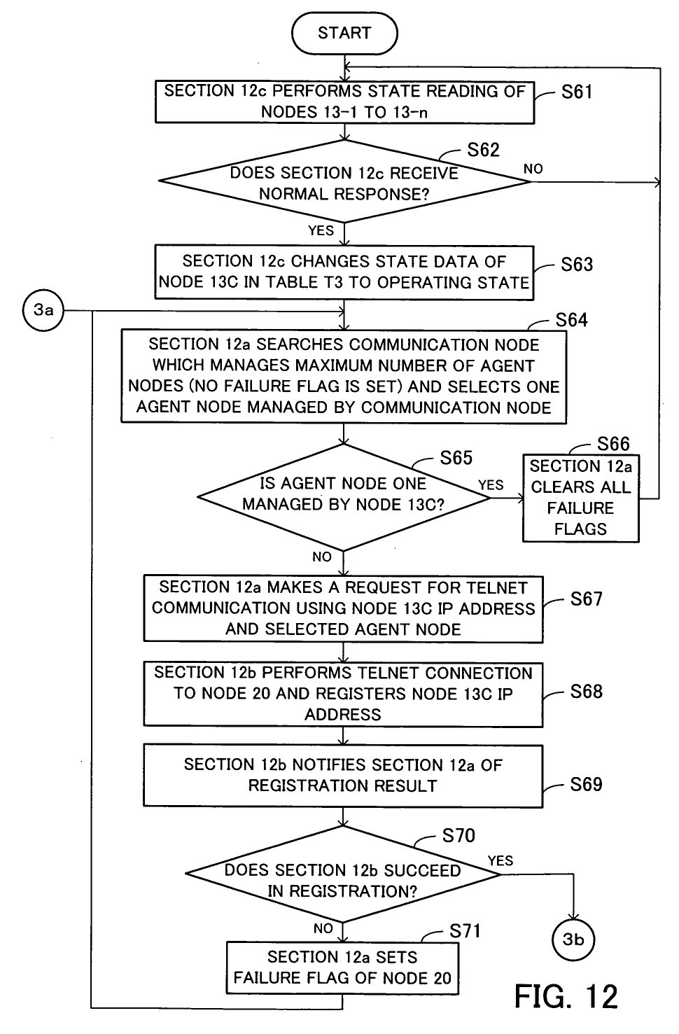

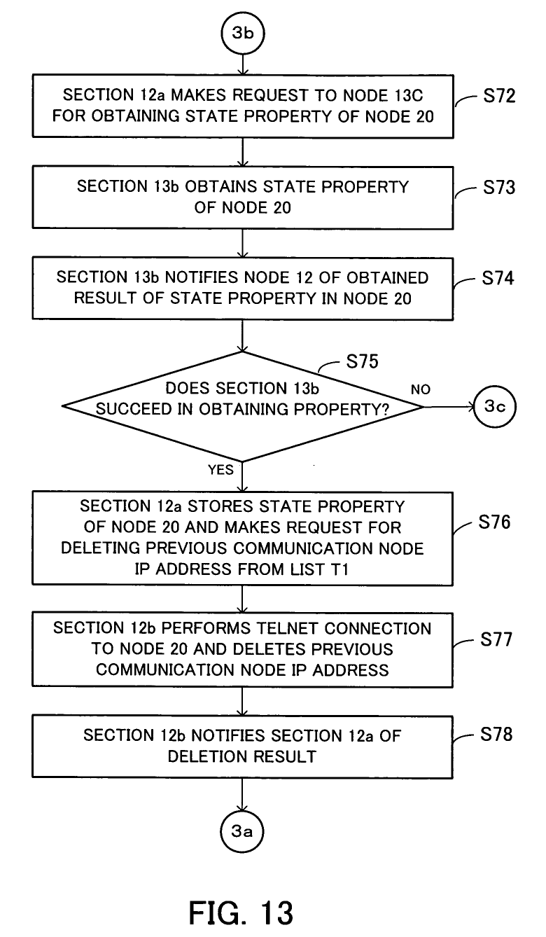

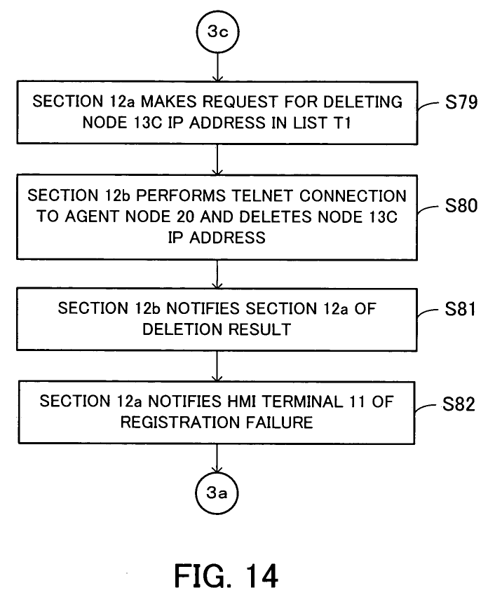

Next, operations of the network management system 1 will be described using flowcharts. FIGS. 6 and 7 show operations of agent node registration, FIGS. 8 to 10 show operations of agent node storage change when the communication node is in an abnormal state, FIG. 11 shows operations of agent node deletion and FIGS. 12 to 14 show operations of communication node restoration, respectively.

FIGS. 6 and 7 are flowcharts showing operations of agent node registration.

An operator inputs registration request data in the HMI terminal 11. The registration request data inputted by the operator are an IP address, a user name/password of TELNET information and an SNMP community property (a community name registered in the access list T1) of the agent node (referred to as an agent node 20) to be newly registered. When these data are inputted, the HMI terminal 11 makes a registration request to the agent management section 12a within the main node 12 (step S1).

By referring to the state data in the communication node management table T3 and the communication node data in the agent management table T2, the section 12a determines a communication node (referred to as a communication node 13) which is at work as well as which has a lowest processing load (the number of registered agent nodes is low). Further, using an IP address of the determined communication node 13 and registration request data received from the HMI terminal 11, the section 12a makes a request to the TELNET communication section 12b for the registration in the access list T1 (step S2).

The TELNET communication section 12b performs TELNET connection to the agent node 20 through the communication section 12e using the IP address of the agent node 20 and the user name/password of the TELNET information. Further, the section 12b subjects the access list T1 of the agent node 20 to the registration processing of the IP address of the communication node 13 using the SNMP community property and communication node IP address received from the agent management section 12a (step S3).

The TELNET communication section 12b notifies the agent management section 12a of registration results in the access list T1 (step S4).

When the section 12b succeeds in the registration, the process goes to step S7, whereas when the section 12b fails in the registration, the process goes to step S6 (step S5).

The agent management section 12a notifies the HMI terminal 11 of the registration failure and the process is completed (step S6).

The section 12a notifies the communication node 13 registered in the access list T1 of the IP address and SNMP community property of the agent node 20 to make a request to the node 13 for obtaining the state properties of the agent node 20 (step S7).

Using the agent node 20 IP address and SNMP community property received from the agent management section 12a, the SNMP communication section 13b within the communication node 13 performs SNMP communication with the agent node 20 to perform processing for obtaining the state properties of the agent node 20 (step S8).

The section 13b notifies the agent management section 12a of the obtained results (step S9).

When the section 13b succeeds in obtaining the properties, the process goes to step S11, whereas when the section 13b fails in obtaining the properties, the process goes to step S12 (step S10).

The agent management section 12a sets information corresponding to the agent node 20 in the agent management table T2 in respective columns of “communication node”, “TELNET information” and “SNMP community property”. Further, the section 12a stores the state properties of the agent node 20 in the agent state DB 12d and notifies the HMI terminal 11 of the success in agent registration, whereby the registration is completed (step S11).

The section 12a makes a request to the TELNET communication section 12b for deleting the IP address information of the communication node 13 in the access list T1 (step S12).

The TELNET communication section 12b performs TELNET connection to the agent node 20 through the communication section 12e using the IP address of the agent node 20 and the user name/password of the TELNET information. Further, the section 12b deletes the communication node 13 IP address described in the access list T1, which accords with the SNMP community property and communication node IP address received from the agent management section 12a (step S13).

The TELNET communication section 12b notifies the agent management section 12a of the deletion results in the access list T1 (step S14).

The agent management section 12a notifies the HMI terminal 11 of the failure in agent registration and the process is completed (step S15).

FIGS. 8 to 10 are flowcharts showing operations of agent node storage change when the communication node is in an abnormal state.

The system management section 12c periodically performs state reading of the communication nodes 13-1 to 13-n through the node management section 13a (step S21).

When the section 12c receives an abnormal response from the node management section 13a, the process goes to step S23, whereas when the section 12c receives no abnormal response, the process returns to step S21 (step S22).

For an abnormal communication node (referred to as an abnormal communication node 13A), the section 12c changes the state data in the communication node management table T3 from an “operating state” to a “stop state”. Further, the section 12c notifies the agent management section 12a of the stopped abnormal communication node 13A (step S23).

By referring to the communication node data in the agent management table T2, the agent management section 12a searches whether an agent node (on which no failure flag is placed) which performs SNMP communication with the stopped abnormal communication node 13A is present or not (step S24).

When there is an agent node on which no failure flag is placed and which is managed by the stopped abnormal communication node 13A, the process goes to step S27, whereas when there is no agent node as described above, the process goes to step S26 (step S25).

The section 12a clears all the failure flags in the agent management table T2 and the process returns to step S21 (step S26).

By referring to the state data in the communication node management table T3 and the communication node data in the agent management table T2, the section 12a determines a communication node (referred to as a normal communication node 13B) which is at work as well as which has a lowest processing load (the number of registered agent nodes is low). Further, using an IP address of the determined normal communication node 13B and data (data relating to the agent node 20 described in the agent management table T2) on the agent node (referred to as an agent node 20) hit by the search in step S24, the section 12a makes a request to the TELNET communication section 12b for the TELNET communication (step S27).

The TELNET communication section 12b performs TELNET connection to the agent node 20 through the communication section 12e using the IP address of the agent node 20 and the user name/password of the TELNET information. Further, the section 12b subjects the access list T1 of the agent node 20 to the registration processing of the IP address of the normal communication node 13B using the SNMP community property and communication node IP address received from the agent management section 12a (step S28).

The TELNET communication section 12b notifies the agent management section 12a of the registration results in the access list T1 (step S29).

When the section 12b succeeds in the registration, the process goes to step S32, whereas when the section 12b fails in the registration, the process goes to step S31 (step S30).

The agent management section 12a sets in the agent management table T2 a failure flag of the agent node 20 and changes the state of the agent node 20 from a monitoring state to a non-monitoring state. Then, the section 12a notifies the HMI terminal 11 of the agent registration failure and the process returns to step S24 (step S31).

The section 12a notifies the normal communication node 13B registered in the access list T1 of the IP address and SNMP community property of the agent node 20 to make a request to the node 13B for obtaining state properties of the agent node 20 (step S32).

Using the agent node 20 IP address and SNMP community property received from the agent management section 12a, the SNMP communication section 13b within the normal communication node 13B performs SNMP communication with the agent node 20 to perform a processing for obtaining the state properties of the agent node 20 (step S33).

The section 13b notifies the agent management section 12a of the obtained results (step S34).

When the section 13b succeeds in obtaining the properties, the process goes to step S36, whereas when the section 13b fails in obtaining the properties, the process goes to step S39 (step S35).

The agent management section 12a updates the communication node data in the agent management table T2 (the section 12a changes the abnormal communication node 13A to the normal communication node 13B), and stores the state properties of the agent node 20 in the agent state DB 12d. Further, the section 12a makes a request to the TELNET communication section 12b for deleting the IP address of the stopped abnormal communication node 13A from the access list T1 (step S36).

The TELNET communication section 12b performs TELNET connection to the agent node 20 through the communication section 12e using the IP address of the agent node 20 and the user name/password of the TELNET information. Further, the section 12b deletes the abnormal communication node 13A IP address described in the access list T1, which accords with the SNMP community property and communication node IP address received from the agent management section 12a (step S37).

The TELNET communication section 12b notifies the agent management section 12a of deletion results in the access list T1, and the process returns to step S24 (step S38).

The agent management section 12a makes a request to the TELNET communication section 12b for deleting the IP address information of the normal communication node 13B in the access list T1 (step S39).

The TELNET communication section 12b performs TELNET connection to the agent node 20 through the communication section 12e using the IP address of the agent node 20 and the user name/password of the TELNET information. Further, the section 12b deletes the normal communication node 13B IP address described in the access list T1, which accords with the SNMP community property and communication node IP address received from the agent management section 12a (step S40).

The TELNET communication section 12b notifies the agent management section 12a of the deletion results in the access list T1 (step S41).

The section 12a sets in the agent management table T2 a failure flag of the agent node 20 and changes the state of the agent node 20 from a monitoring state to a non-monitoring state. Then, the section 12a notifies the HMI terminal 11 of the agent registration failure (step S42).

In the above description, when the section 12b fails in the registration in the access list (step S30), the storage change failure flag is placed on (step S31). At this time, by again referring to the communication node data in the agent management table T2, the agent management section 12a searches another agent node on which no failure flag is placed and which is managed by the stopped abnormal communication node 13A (step S24). When discovering the agent node like this, the section 12b similarly subjects the access list T1 to the registration processing.

Herein, there is repeated the operation where when the section 12b fails in the registration in the access list, the process returns to step S24 from step S31. As a result, when the agent node on which no failure flag is placed goes out of existence, that is, when a failure flag is placed on the whole remaining agent nodes, the process goes to step S26 from the determination in step S25 and all of the failure flags are cleared. Then, a storage change operation flow newly starts from step S21.

FIG. 11 is a flowchart showing the operation of agent node deletion.

An operator sets through the HMI terminal 11 an agent node desired to be deleted (referred to as the agent node 20). The HMI terminal 11 makes a request to the agent management section 12a for deleting the agent node (step S51).

The agent management section 12a searches the communication node data in the agent management table T2 and obtains information of the agent node 20 to be deleted. Using the obtained information, the section 12a makes a request to the TELNET communication section 12b for deleting the address of the communication node (referred to as the communication node 13) registered in the access list T1 of the agent node 20 (step S52).

The TELNET communication section 12b performs TELNET connection to the agent node 20 through the communication section 12e using the IP address of the agent node 20 and the user name/password of the TELNET information. Further, the section 12b subjects the access list T1 of the agent node 20 to the deletion processing of the IP address of the normal communication node 13B using the SNMP community property and communication node IP address received from the agent management section 12a (step S53).

The TELNET communication section 12b notifies the agent management section 12a of deletion results in the access list T1 (step S54).

The agent management section 12a deletes information on the agent node 20 from the agent management table T2 and the agent state DB 12d, and notifies the HMI terminal 11 of deletion completion (step S55).

FIGS. 12 to 14 are flowcharts showing operations at the time when a communication node is restored.

The system management section 12c periodically performs state reading of the communication nodes 13-1 to 13-n through the node management section 13a (step S61).

When the section 12c receives a normal response from an abnormal communication node, the process goes to step S63, whereas when the section 12c receives no normal response, the process returns to step S61 (step S62).

For a normal communication node (referred to as a restoration communication node 13C), the system management section 12c changes the state data in the communication node management table T3 from a “stopped state” to an “operating state”. Further, the section 12c notifies the agent management section 12a of the restoration communication node 13C (step S63).

The agent management section 12a searches from the agent management table T2 a communication node (a high-load communication node) which manages the maximum number of agent nodes (no failure flag is set), and selects one agent node managed by the communication node (step S64).

The section 12a determines whether or not the selected agent node is one which performs the SNMP communication with the restoration communication node 13C. When the agent node is one (on which no failure flag is placed) managed by the restoration communication node 13C, the process goes to step S66, whereas when the agent node is not one managed by the restoration communication node 13C, the process goes to step S67 (step S65).

The section 12a clears all the failure flags in the agent management table T2 (step S66).

Using an IP address of the restoration communication node 13C and the information on the selected agent node (referred to as the agent node 20) described in the agent management table T2, the section 12a makes a request to the TELNET communication section 12b for the TELNET communication (step S67).

The TELNET communication section 12b performs TELNET connection to the agent node 20 through the communication section 12e using the IP address of the agent node 20 and the user name/password of the TELNET information. Further, the section 12b subjects the access list T1 of the agent node 20 to the registration processing of the IP address of the restoration communication node 13C using the SNMP community property and communication node IP address received from the agent management section 12a (step S68).

The TELNET communication section 12b notifies the agent management section 12a of the registration results in the access list T1 (step S69).

When the section 12b succeeds in the registration, the process goes to step S72, whereas when the section 12b fails in the registration, the process goes to step S71 (step S70).

The agent management section 12a sets in the agent management table T2 a failure flag of the agent node 20, and the process returns to step S64 (step S71).

The section 12a notifies the restoration communication node 13C registered in the access list T1 of the IP address and SNMP community property of the agent node 20 to make a request to the node 13C for obtaining state properties of the agent node 20 (step S72).

Using the agent node 20 IP address and SNMP community property received from the agent management section 12a, the SNMP communication section 13b within the restoration communication node 13C performs SNMP communication with the agent node 20 to perform processing for obtaining the state properties of the agent node 20 (step S73).

The section 13b notifies the agent management section 12a of the obtained results (step S74).

When the section 13b succeeds in obtaining the properties, the process goes to step S76, whereas when the section 13b fails in obtaining the properties, the process goes to step S79 (step S75).

The agent management section 12a updates the communication node data in the agent management table T2 (the section 12a changes the previous communication node to the restoration communication node 13C), and stores the state properties of the agent node 20 in the agent state DB 12d. Further, the section 12a makes a request to the TELNET communication section 12b for deleting the IP address of the previous communication node from the access list T1 (step S76).

The TELNET communication section 12b performs TELNET connection to the agent node 20 through the communication section 12e using the IP address of the agent node 20 and the user name/password of the TELNET information. Further, the section 12b deletes the previous communication node IP address described in the access list T1, which accords with the SNMP community property and communication node IP address received from the agent management section 12a (step S77).

The TELNET communication section 12b notifies the agent management section 12a of deletion results in the access list T1, and the process returns to step S64 (step S78).

The agent management section 12a makes a request to the TELNET communication section 12b for deleting the IP address information of the restoration communication node 13C in the access list T1 (step S79).

The TELNET communication section 12b performs TELNET connection to the agent node 20 through the communication section 12e using the IP address of the agent node 20 and the user name/password of the TELNET information. Further, the section 12b deletes the restoration communication node 13C IP address described in the access list T1, which accords with the SNMP community property and communication node IP address received from the agent management section 12a (step S80).

The TELNET communication section 12b notifies the agent management section 12a of the deletion results in the access list T1 (step S81).

The section 12a sets in the agent management table T2 a failure flag of the agent node 20 and changes the state of the agent node 20 from a monitoring state to a non-monitoring state. Then, the section 12a notifies the HMI terminal 11 of the registration failure (step S82).

In the above description, when the section 12b fails in the registration in the access list (step S70), the storage change failure flag is placed on (step S71). At this time, by again referring to the communication node data in the agent management table T2, the agent management section 12a searches the communication node which manages the maximum number of agent nodes (on which no failure flag is set) and selects another agent node which is not previously selected (step S64). When the agent node is not managed by the restoration communication node, the section 12b similarly subjects the access list T1 to the registration processing.

Herein, there is repeated the operation where when the section 12b fails in the registration in the access list, the process returns to step S64 from step S71. As a result, when the agent node on which no failure flag is placed goes out of existence, that is, when a failure flag is placed on the whole remaining agent nodes, the process goes to step S66 from the determination in step S65 and all of the failure flags are cleared. Then, a communication node restoration operation flow newly starts from step S61.

Next, control in a case of equalizing loads of the communication nodes 13-1 to 13-n will be described. The system management section 12c within the main node 12 periodically obtains and confirms the processing loads of the communication nodes 13-1 to 13-n.

At this time, when detecting a communication node having an excessive processing load (an overload communication node), the section 12c selects an agent node (a switched object agent node) as a communication switched object from among a plurality of agent nodes which performs the SNMP communication with the overload communication node.

Further, the agent management section 12a deletes an address of the overload communication node from the access list of the switched object agent node to thereby cut off communication between the overload communication node and the switched object agent node. Then, in the access list of the switched object agent node of which the communication with the overload communication node is once cut off, the section 12a registers an address of another communication node having a low processing load to thereby restart communication. By the address registration control like this, the processing load of the whole communication node can be equalized.

Next, a security control of the network management system 1 will be described. The agent node 20 is allowed to have an illegal packet detection function for detecting an illegal packet. Further, the agent management section 12a within the main node 12 registers a plurality of communication node addresses in one agent node having the illegal packet detection function.

In such a construction, when detecting an illegal packet which gains illegal access using the SNMP, the agent node 20 determines an illegal communication node as a transmission source of the illegal packet. Further, the agent node 20 transmits a determination result (determine which communication node transmits an illegal packet) to a legal communication node having an address other than that of the illegal communication node among addresses currently registered in the access list T1. By the security control like this, improvement in security of the SNMP communication can be attained.

As described above, according to the network management system 1, when monitoring the agent through the manager which structures a distributed environment, the need for previously setting an access list on the agent side is eliminated.

Conventionally, when it is not known which communication node in a distributed environment communicates with an agent, all of the IP addresses of communication nodes of the manager are registered in the respective agents. However, in the network management system 1, an address of the communication node is automatically registered in an agent node to be accessed by the communication node, so that efficient address registration can be performed.

Further, also when the access list on the agent side must be changed by failure or removal of a communication node, registration in the access list of the agent can be automatically performed again from the manager side. Therefore, also when restructuring the distributed environment, a flexible response can be made.

Further, also when deleting an agent from a monitored object, an address of a communication node registered in an access list is automatically deleted. Therefore, unnecessary resources are automatically open, so that enhancement of convenience in view of management can be attained.

The network management system of the present invention has an agent node having an access list for registering an address of a partner to be permitted to make access and a plurality of communication nodes for performing communication with the agent node by a network management protocol. In the system, addresses of the communication nodes are automatically registered in the access list of the agent node to allow a manager side to manage the addresses to be registered in the agent node. As a result, operability and maintainability of the access list is improved, so that efficiency of the network management can be attained.

The foregoing is considered as illustrative only of the principles of the present invention. Further, since numerous modifications and changes will readily occur to those skilled in the art, it is not desired to limit the invention to the exact construction and applications shown and described, and accordingly, all suitable modifications and equivalents may be regarded as falling within the scope of the invention in the appended claims and their equivalents.

What is claimed is:

1. A network management system for managing, using a network management protocol, a network device connected to a network, comprising:
an agent node as the network device having an access list for registering an address of a partner to be permitted to make access, the agent node performing communication by the network management protocol only with the partner registered in the access list, and
a manager server having a plurality of communication nodes for performing communication by the network management protocol with the agent node, and a main node for controlling automatic registration of addresses of the communication nodes in the access list to allow a manager side to manage the addresses to be registered in the agent node, the manager server performing distributed processing of a device management of the agent node by the plurality of communication nodes.

2. The network management system according to claim 1, wherein:
when an agent node as a managed object is newly registered, the main node selects from the plurality of communication nodes a communication node having a lowest processing load and automatically registers an address of the selected communication node in an access list of the agent node to be newly registered.

3. The network management system according to claim 1, wherein:
when monitoring an operating state of the communication nodes and detecting an abnormal communication node with an abnormal operating state, the main node deletes an address of the abnormal communication node from the access list of the agent node which performs communication by the network management protocol with the abnormal communication node and registers in the access list an address of a communication node with a normal operating state, whereby a storage change of the agent node is automatically performed.

4. The network management system according to claim 1, wherein:
when monitoring an operating state of the communication nodes and detecting a restoration communication node restored from an abnormal state to a normal state, the main node searches a high-load communication node currently having a highest processing load to thereby select a switched object agent node as a communication switched object from among a plurality of agent nodes which perform communication by the network management protocol with the high-load communication node, deletes an address of the high-load communication node from an access list of the switched object agent node to thereby cut off communication between the high-load communication node and the switched object agent node and registers, in the access list of the switched object agent node of which communication with the high-load communication node is once cut off, an address of another communication node having a low processing load, whereby a storage change of the agent node is automatically performed.

5. The network management system according to claim 1, wherein:
when monitoring an operating state of the communication nodes and detecting an overload communication node having an excessive processing load, the main node selects a switched object agent node as a communication switched object from among a plurality of agent nodes which perform communication with the overload communication node, deletes an address of the overload communication node from an access list of the switched object agent node to thereby cut off communication between the overload communication node and the switched object agent node and registers, in the access list of the switched object agent node of which the communication with the overload communication node is once cut off, an address of another communication node having a low processing load to thereby restart communication, whereby a processing load of the whole communication node is equalized.

6. The network management system according to claim 1, wherein:
after allowing the agent node to have an illegal packet detection function for detecting an illegal packet, the main node registers a plurality of communication node addresses in one agent node having the illegal packet detection function, and wherein:
when detecting an illegal packet which gains illegal access using the network management protocol, the agent node determines an illegal communication node as a transmission source of the illegal packet and transmits a determination result to a legal communication node having an address other than that of the illegal communication node among addresses currently registered in the access list.
